(19) United States
(12) Patent Application Publication
(10) Pub. No.: US 2022/0353335 A1
(43) Pub. Date: Nov. 3, 2022

(54) SESSION ESTABLISHMENT IN REMOTE DESKTOP INFRASTRUCTURE ENVIRONMENTS

(71) Applicant: MICROSOFT TECHNOLOGY LICENSING, LLC, Redmond, WA (US)

(72) Inventors: Jinhua FEI, Bellevue, WA (US); Prasanna Chromepet PADMANABHAN, Redmond, WA (US); Vladimir Kostadinov STOYANOV, Redmond, WA (US); Parvez Mohmedrajak PATHAN, Redmond, WA (US); Ales NOVAK, Redmond, WA (US); Michael LACHER, Redmond, WA (US); Sandeep PATNAIK, Redmond, WA (US)

(21) Appl. No.: 17/243,472

(22) Filed: Apr. 28, 2021

(51) Int. Cl. H04L 29/08; H04L 29/06; H04L 29/12

(52) U.S. Cl. CPC H04L 67/141; H04L 67/025; H04L 67/40; H04L 67/42; H04L 61/6063

(57) ABSTRACT

Technologies for performing secure session establishment in remote desktop infrastructure environments are disclosed. A remote desktop client application obtains client candidate network addresses using the Interactivity Connectivity Establishment (“ICE”) protocol and provides the client candidate network addresses to an instance of a remote desktop server application. The instance of the remote desktop server application obtains server candidate network addresses also using the ICE protocol and provides the server candidate network addresses to the remote desktop client application. The remote desktop client application and remote desktop server application evaluate the client network addresses and select a pair of network addresses for establishing a remote desktop networking session using the ICE protocol. The remote desktop client application and remote desktop server establish the network session using a remote desktop protocol over User Datagram Protocol (“UDP”). Additional remote desktop transport channels can be established in a similar fashion.

### BACKGROUND

Remote desktop technologies allow a user that is physically interacting with a local computer to control and view a remote desktop session originating from a remotely located computer. The local computer is commonly referred to as a remote desktop client computer, or simply a “client computer,” while the remote computer is commonly referred to as a remote desktop session host.

A remote desktop client application running on a client computer and a remote desktop server application running on a remote desktop session host together facilitate “remoting” a desktop session. The remote desktop client application receives user input, such as keyboard or mouse input, and converts the input into a network-compatible representation to be transmitted to the remote desktop server application.

The remote desktop server application running on the remote desktop session host receives the network-compatible representation of the user input and converts this representation into input messages. The remote desktop session host processes the input messages as if they were generated locally. Therefore, applications running on the remote desktop session host respond to input made at the client computer as if the input was generated locally to the remote desktop session host.

In addition, applications and the operating system running on the remote desktop session host periodically generate graphics output. In a remote desktop infrastructure environment, the graphics output of a remote desktop session host is typically not displayed on a monitor or other viewing device attached to the host. Instead, the remote desktop server application converts the graphics output to a network-compatible representation and transmits the representation to the client computer. The network-compatible representation is received by the remote desktop client application and dis- played on a display device attached to the client computer. Using this mechanism, a user can utilize a client computer to interact with and utilize the operating system and applications executing on a remote desktop session host as if they were physically co-located.

In many remote desktop infrastructure environments, networking devices implementing the network address translation (“NAT”) protocol (and potentially other security protocols, firewalls, etc.) may be utilized on the private networks upon which remote desktop client computers reside. Similarly, NAT devices and other network security devices might also be implemented on the private networks hosting remote desktop session hosts. These devices provide improved network security to devices located on the respective private networks but, at the same time, can make establishing network sessions between remote desktop clients and remote desktop session hosts on different private networks difficult.

To overcome this challenge, remote desktop sessions have traditionally been established using the WebSocket protocol over a Transmission Control Protocol (“TCP”) connection using a gateway. For instance, a remote desktop client computer might establish a WebSocket TCP connection to a gateway located within the private network of a remote desktop session host. The remote desktop session host might also, in turn, establish a Web Socket TCP connection to the same gateway to enable communication with the remote desktop client computer therethrough.

The solution described above for session establishment in remote desktop infrastructure environments has several technical disadvantages. In particular, the WebSocket protocol is not ideal for long-lived network connections such as remote desktop sessions. As a result, remote desktop clients and remote desktop session hosts can be frequently disconnected from one another. This can be frustrating for users, reduce productivity, and unnecessarily utilize computing resources to reestablish remote desktop sessions. Additionally, the TCP protocol is not ideal for use with remote desktop connections, particularly on noisy networks. For instance, the TCP protocol can be aggressive in how it handles retransmission on noisy networks, which can significantly impact the performance of remote desktop sessions.

It is with respect to these and other technical challenges that the disclosure made herein is presented.

### SUMMARY

Technologies are disclosed for performing session establishment in remote desktop infrastructure environments. Through implementations of the disclosed technologies, remote desktop networking sessions can be securely established between remote desktop client computers and remote desktop session hosts in environments where NAT devices are present and in a manner that does not utilize the Web Socket protocol or the TCP protocol. As a result, secure remote desktop sessions can be established and maintained that are more performant and that do not disconnect as frequently as when previously solutions are utilized. Other technical benefits not specifically mentioned herein can also be realized through implementations of the disclosed subject matter.

In order to realize the technical benefits mentioned briefly above, a remote desktop client application obtains client candidate network addresses using the Interactivity Connectivity Establishment (“ICE”) protocol and provides the client candidate network addresses to an instance of a remote desktop server application. The client candidate network addresses can include host candidates, reflexive candidates, and relayed candidates. The client candidate network addresses might be referred to herein as “client candidate addresses” or “client candidates.”

The instance of the remote desktop server application obtains server candidate network addresses also using the ICE protocol and provides the server candidate network addresses to the remote desktop client application. The server candidate network addresses can also include host candidates, reflexive candidates, and relayed candidates. The server candidate network addresses might be referred to herein as “server candidate addresses” or “server candidates.”

The remote desktop client application and remote desktop server application evaluate the client network addresses using the ICE protocol to select a pair of network addresses for establishing a communication session. The remote desktop client application and remote desktop server application establish a remote desktop protocol over User Datagram Protocol (“UDP”) network session using the selected network addresses. The network session, or connection, might be established using local network addresses, might be relayed, such as through a media relay service implementing the Traversal Using Relays around NAT (“TURN”) protocol), or using translated transport addresses on the public side of a NAT device, or devices. The remote desktop client application and remote desktop server application can then transmit remote desktop protocol data over the established network connection.

As discussed briefly above, implementations of the technologies disclosed herein can enable establishment of remote desktop sessions between remote desktop client computers and remote desktop session hosts even when NAT devices are present and remote desktop sessions that are more performant and that do not disconnect as frequently as compared to when previous solutions are utilized. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that shows aspects of an illustrative remote desktop infrastructure environment in which embodiments of the disclosed technologies can be implemented, according to embodiments disclosed herein;

FIG. 2A is a network timing diagram that shows aspects of one mechanism disclosed herein for utilizing the ICE protocol to collect candidate client and server network addresses for use in establishing a network connection between a remote desktop client computer and a remote desktop session host, according to one embodiment disclosed herein;

FIG. 2B is a network timing diagram that shows aspects of one mechanism disclosed herein for evaluating candidate client and server network addresses for use in establishing a network connection between a remote desktop client computer and a remote desktop session host, according to one embodiment disclosed herein;

FIG. 2C is a network timing diagram that shows aspects of one mechanism disclosed herein for establishing additional remote desktop communication channels between a remote desktop client computer and a remote desktop session host, according to one embodiment disclosed herein;

FIG. 3 is a flow diagram showing a routine that illustrates aspects of the operation of the remote desktop client computer and the remote desktop session host described with reference to FIGS. 1-2C for establishing a remote desktop session, according to one embodiment disclosed herein;

FIG. 4 is a computer architecture diagram showing an illustrative computer hardware and software architecture for a computing device that can implement aspects of the technologies presented herein; and

FIG. 5 is a network diagram illustrating a distributed computing environment in which aspects of the disclosed technologies can be implemented.

### DETAILED DESCRIPTION

The following detailed description is directed to technologies for session establishment and communication in remote desktop infrastructure environments. As discussed briefly above, implementations of the technologies disclosed herein can enable secure establishment of remote desktop networking sessions between remote desktop client computers and remote desktop session hosts that are behind NAT devices and remote desktop sessions that are more performant and that do not disconnect as frequently as compared to previous solutions. Other technical benefits not specifically mentioned herein can also be realized through implementations of the disclosed subject matter.

While the subject matter described herein is presented in the general context of connection establishment and maintenance between remote desktop client computers and remote desktop session hosts, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation etc.), mini-computers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for performing session establishment in remote desktop infrastructure environments will be described.

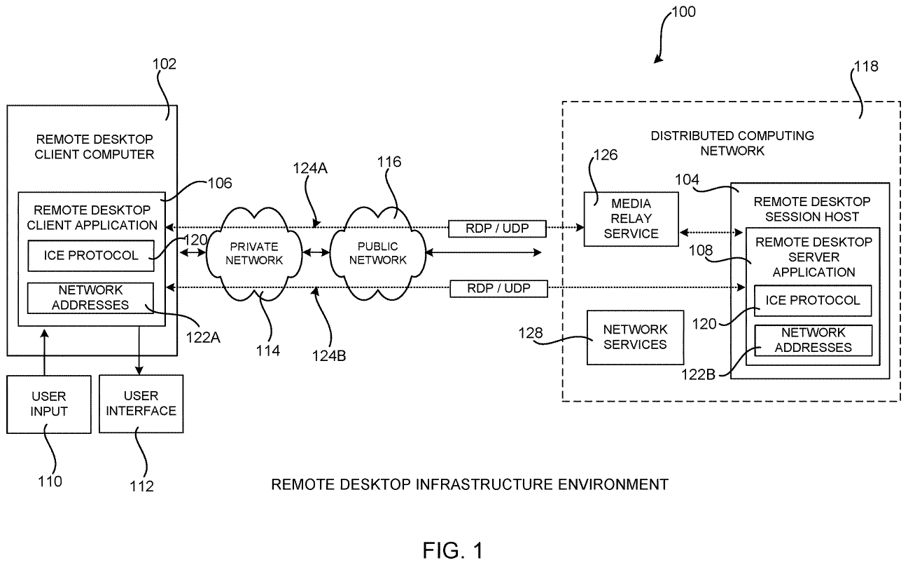

FIG. 1 is a computing architecture diagram that shows aspects of an illustrative remote desktop infrastructure environment 100 in which the disclosed technologies can be implemented, according to embodiments disclosed herein. As discussed briefly above, remote desktop technologies allow a user interacting with remote desktop client computer 102 to control and view a remote desktop session originating from a remote desktop session host 104. In order to provide this functionality, the remote desktop client computer 102 typically executes a remote desktop client application 106 and the remote desktop session host 104 executes a remote desktop server application 108.

The applications 106 and 108 together facilitate “remoting” a desktop session. In particular, the remote desktop client application 106 receives user input 110 from a user, such as keyboard or mouse input, and converts the user input 110 into a network-compatible representation to be transmitted to the remote desktop session host 104. The remote desktop server application 108 running on the remote desktop session host 104, in turn, receives the network-compatible representation of the user input 110 and converts this representation into input messages. The remote desktop session host 104 processes the input messages as if they were generated locally thereto. Therefore, applications and the operating system running on the remote desktop session host 104 respond to user input 110 made at the remote desktop client computer 102 as if the input was generated by a user physically proximate to the remote desktop session host 104.

In addition, applications and an operating system (not shown in FIG.1) executing on the remote desktop session host 104, periodically generate graphics output. In the remote desktop infrastructure environment 100, the graphics output of a remote desktop session host 104 is typically not displayed on a monitor or other viewing device attached to the host 104. Instead, the remote desktop server application 108 converts the graphics output to a network-compatible representation and transmits the representation to the remote desktop client computer 102.

The network-compatible representation of the graphics output is received by the remote desktop client application 106 and presented by way of a user interface 112 on a display device (not shown in FIG. 1) attached to the remote desktop client computer 102. Using this mechanism, a user can utilize the remote desktop client computer 102 to interact with and utilize the operating system and applications executing on the remote desktop session host 104 in much the same manner as if they were local to the remote desktop session host 104.

As shown in FIG. 1, various types of network devices and topologies may be utilized to establish a remote desktop session between a remote desktop client computer 102 and a remote desktop session host 104. For example, the remote desktop client computer 102 might be located on a private network 114 that includes networking devices implementing the network address translation (“NAT”) protocol (and potentially other security protocols, firewalls, etc.). Similarly, remote desktop session hosts 104 might be located in a distributed computing network 118 provided by a cloud service provider that also includes many types of networking devices such as, but not limited to, devices implementing the NAT protocol and other network security protocols.

The private network 114 and the distributed computing network 118 can be connected via one or more public networks 116, such as the Internet. The remote desktop client computer 102 is commonly implemented as a desktop or laptop computing device while the remote desktop session host 104 might be implemented as a physical server computer or a virtual machine. Other implementations can also be utilized. In this regard, it is to be appreciated that the networking topology shown in FIG. 1 has been simplified for discussion purposes and that many other networks and networking devices may be present than illustrated in FIG. 1.

As discussed briefly above, networking devices implementing the NAT protocol in the private network 114 and the distributed computing network 118 provide improved security to devices located within these networks but, at the same time, can make establishing network sessions between remote desktop client computers 102 and remote desktop sessions hosts 104 in these networks difficult. To overcome this technical limitation, remote desktop sessions have traditionally been established using the Web Socket protocol over transmission control protocol (“TCP”) using a gateway (not shown in FIG. 1).

For instance, a remote desktop client computer 102 might establish a WebSocket TCP connection to a gateway within the private network (e.g., the distributed computing network 118) of a remote desktop session host 104. The remote desktop session host 104 might also, in turn, establish a Web Socket TCP connection to the same gateway to enable communication with the remote desktop client computer 102 therethrough. Remote desktop protocol data can then be exchanged between the remote desktop client computer 102 and the remote desktop session host 104 by way of the gateway.

As mentioned previously, the solution described above for session establishment in remote desktop infrastructure environments has several technical disadvantages. In particular, the Web Socket protocol is not ideal for long-lived network connections such as remote desktop sessions. As a result, remote desktop client computers 102 and remote desktop session hosts 104 can be frequently disconnected from one another. This can be frustrating for users, reduce productivity, and unnecessarily utilize computing resources to reestablish remote desktop sessions. Additionally, the TCP protocol is not ideal for use with remote desktop connections, particularly on noisy networks. For instance, the TCP protocol can be aggressive in how it handles retransmission on noisy networks, which can significantly impact the performance of remote desktop sessions. It is with respect to these and other technical challenges that the disclosure made herein is presented.

In order to address the technical challenges set forth above, and potentially others, technologies are disclosed herein for secure and performant network session establishment in a remote desktop infrastructure environment 100. In particular, according to various embodiments disclosed herein, the remote desktop client application 106 and the remote desktop server application 108 are configured to implement the Interactivity Connectivity Establishment (“ICE”) protocol 120 to select network addresses 122 (i.e., one for the remote desktop client application 106 and one for the remote desktop server application 108) for use establishing a network connection 124A or 124B for use in communicating with one another. Once a connection 124A or 124B has been established, remote desktop protocol data can be transmitted between the remote desktop client application 106 and the remote desktop server application 108 using User Datagram Protocol (“UDP”) datagrams, thereby avoiding the shortcomings associated with TCP.

As will be described in greater detail below, the disclosed implementations of the ICE protocol 120 can traverse NAT devices and firewalls, such as those present in the private network 114 and the distributed computing network 118, and establish an efficient network path in terms of media latency to ensure ideal media quality. Details regarding the ICE protocol 120 can be found in the publicly available RFC 5245, Interactive Connectivity Establishment (ICE): A Protocol for Network Address Translator (NAT) Traversal for Offer/Answer Protocols, J. Rosenberg (Apr. 2010). Certain extensions to the ICE protocol are defined in [MS-ICE2] Interactive

Connectivity Establishment (ICE) Extensions documentation (http://msdn.microsoft.com/en-us/library/office/cc431504(v=office.12). aspx).

In the context of the ICE protocol 120, a direct network path (i.e., a path not involving the use of a media relay service 126, such as a service implementing the Traversal Using Relays around NAT (“TURN”) protocol) between endpoints is preferred for a media session over an indirect path (i.e., a path that involves using a media relay service 126). A network path is identified by a pair of network addresses 122, one of which is used to transmit and receive data by an initiating endpoint (e.g., a remote desktop client computer 102) and the other to transmit and receive data by a responding endpoint (e.g., a remote desktop session host 104).

As will be described in greater detail below, the ICE protocol 120 attempts to identify what it deems to be the most efficient path based on static priorities, which are assigned to each of several “candidate pairs” of network addresses that could be used to establish a networking session. A candidate is a network address associated either an initiating endpoint (e.g., a remote desktop client computer 102) or a responding endpoint (e.g., a remote desktop session host 104). A candidate pair is a pair of network addresses, the first network address associated with the initiating endpoint and the second with the responding endpoint.

The term “candidate” relates to the fact that the mechanism implemented by the ICE protocol 120 initially assumes that any transport address associated with an endpoint might be useable for a media session, though it might not actually be useable for various reasons, some of which are described below. The ICE protocol 120 then involves detecting which of the identified candidates are useable and selecting a pair of network addresses 122 from among the candidates for use. Additional details regarding this process will be provided below.

The ICE protocol 120 classifies candidates into three categories: host candidates; reflexive candidates; and relayed candidates. A host candidate is a network address which is local to the endpoint in question (i.e., on a network interface directly attached to the endpoint). For example, the network address of the remote desktop client computer 102 on the private network 114 is local to that device and is therefore a host candidate. Similarly, if the remote desktop client computer 102 were to be directly connected to the public network 116, it would have its own public address on the public network 116, which would also be a host network address. In a similar fashion, the remote desktop session host 104 also has its own local address, or addresses, which are also host candidates.

A reflexive candidate is a network address that is not local to an endpoint, but which is a translated network address on the public side of a NAT device. These are classed into two subcategories: “server reflexive candidates,” which are public NAT addresses discovered by querying a server (e.g., a server implementing the Session Traversal Utilities for NAT (“STUN”) protocol described below), and “peer reflexive candidates,” which are discovered by the other endpoint during the establishment of the media session (e.g., a public side NAT address associated with the initiating endpoint as discovered by the responding endpoint, or vice versa). A relayed candidate is a network address allocated from a media relay service 126, such as a media relay service implementing the TURN protocol.

Additional details regarding the STUN protocol and the TURN protocol, described briefly above, will now be provided. The STUN protocol allows an endpoint to determine whether it is located behind a device implementing the NAT protocol and, if so, to also discover the public address of the NAT device that is mapped to the private address of the initiating endpoint. This effectively gives the endpoint access to the mapping implemented by the NAT so that the endpoint may include the public address in the payload(s) it transmits rather than its own private network address. For example, the remote desktop client application 106 might utilize the STUN protocol to determine the public network address mapped to its network address by a NAT device in the private network 114.

Typically, the STUN protocol works by the initiating endpoint, such as the remote desktop client application 106, sending a query to a STUN server, which is relayed to the STUN server through the NAT device and via the public network as IP datagrams. Because the NAT device replaces the private address in the IP header of the query with the corresponding public address on the public side of the NAT device, the STUN server can obtain the latter from the IP headers of the query, which it can, in turn, provide to the initiating endpoint. The initiating endpoint can then establish a session using that public address rather than its own private address, thereby conveying a useable address at the IP payload level to the responding endpoint in the session request.

A responding endpoint, such as the remote desktop server application 108, can similarly discover its associated public address, which it can convey to the initiating endpoint at the application data level in the response rather than its own private address. The role of a STUN server is effectively one of providing address discovery, and generally it does not participate in a media session once established.

It is to be appreciated that there are circumstances in which a network session cannot be established between endpoints even when the public address of a NAT device is known, for instance when the initiating and/or responding endpoint is behind a symmetric NAT device. In such circumstances, one or more services or servers implementing the TURN protocol can often be used to traverse the NAT by relaying media data, such as remote desktop protocol data. In the embodiment shown in FIG. 1, for example, the media relay service 126 is a network service implemented within the distributed computing network 118 that implements the TURN protocol.

When an endpoint needs to use a TURN relay, such as the media relay service 126, it sends a request requesting that a unique public transport address (i.e., an individual port, provided by the media relay service 126) be allocated to the endpoint. If the request is accepted, the media session is then established using that public address of the media relay service 126 as the source address for that endpoint. That endpoint sends to the media relay service 126 media (e.g., remote desktop protocol data) that it wishes to transmit in the session contained in TURN messages.

The media relay service 126 extracts the media from the TURN messages, and relays it onwards from the public address provided by the media relay service 126 that has been allocated to that endpoint as a source address. The media relay service 126 also relays data intended for that endpoint that has been directed to the address allocated on the media relay service 126 to that endpoint contained in TURN messages for extraction by that endpoint.

If both endpoints are located behind NATs that do not permit STUN, then each will need its own respective transport address to be allocated on the media relay service 126, in which case the media session is established between those two allocated TURN server addresses and each endpoint relays/receives data in TURN messages, with data provided to the media relay service 126 being transmitted and received to/from the two TURN server addresses allocated to those endpoints in the media session.

TURN relaying in the manner described above requires resources, including the unique public transport address, or addresses, allocated on the media relay service 126 to be allocated on that server for at least the duration of that media session, and means that media of the media session travels via a less direct path than when a media session is established directly between the endpoints or via one or more NATs. Though it does require additional resources, TURN relaying in the manner described above can more or less guarantee to provide a useable path through a network for a media session. Additional details regarding these processes can be found in the publicly available RFC 5766: Traversal Using Relays around NAT (TURN): Relay Extensions to Session Traversal Utilities for NAT (STUN).

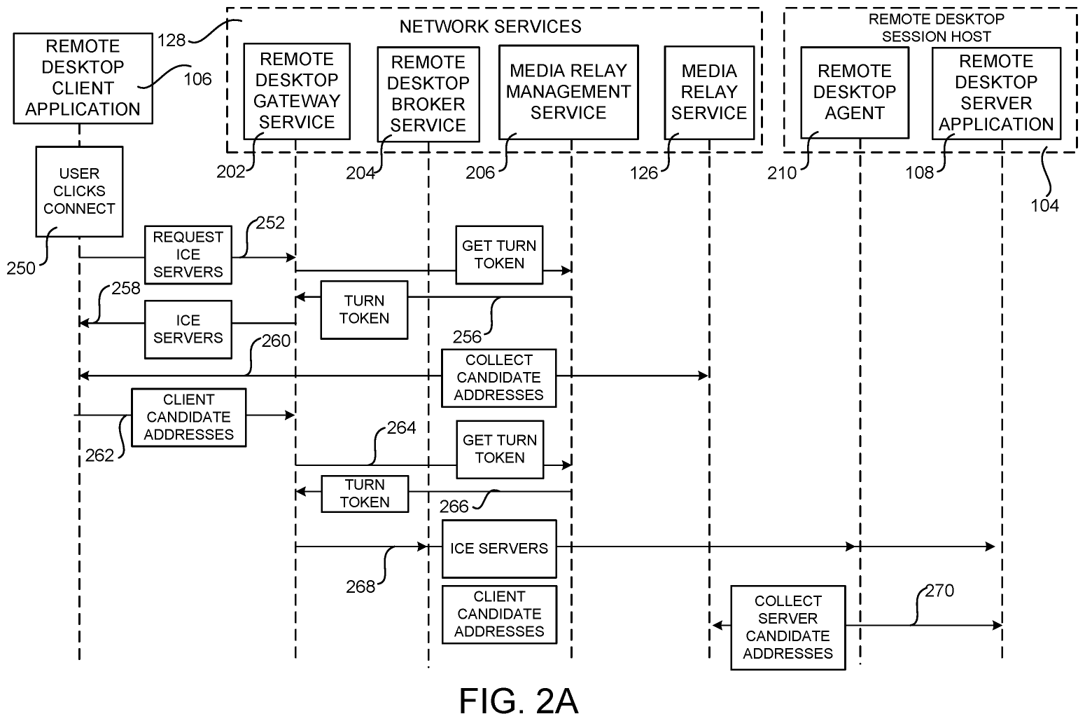

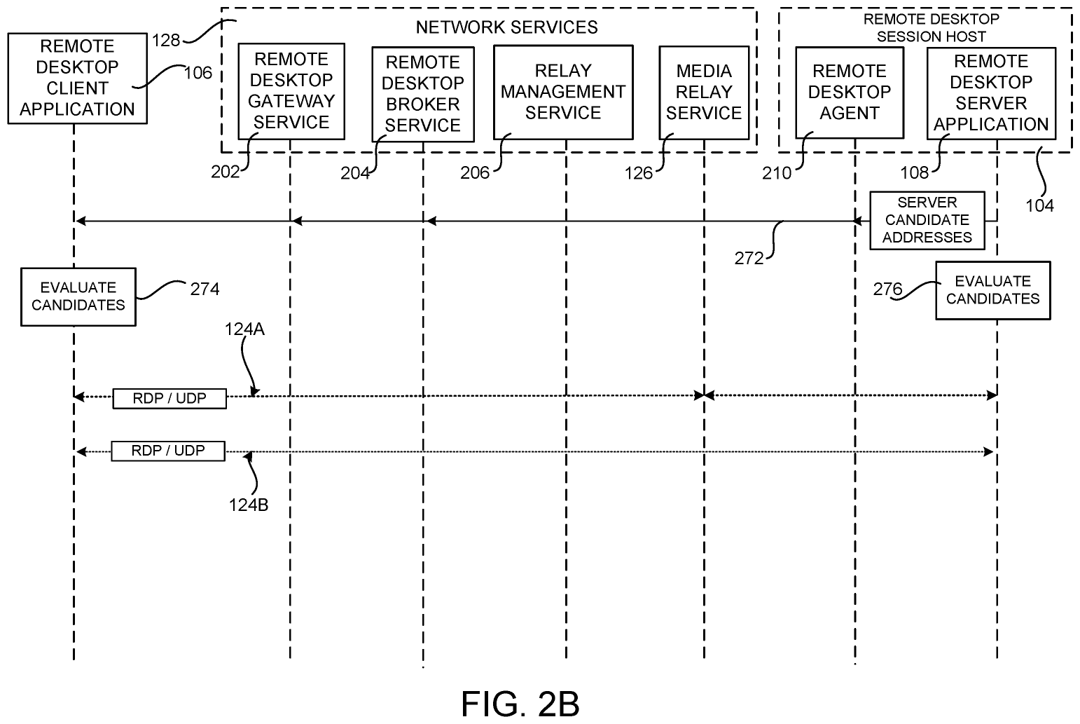

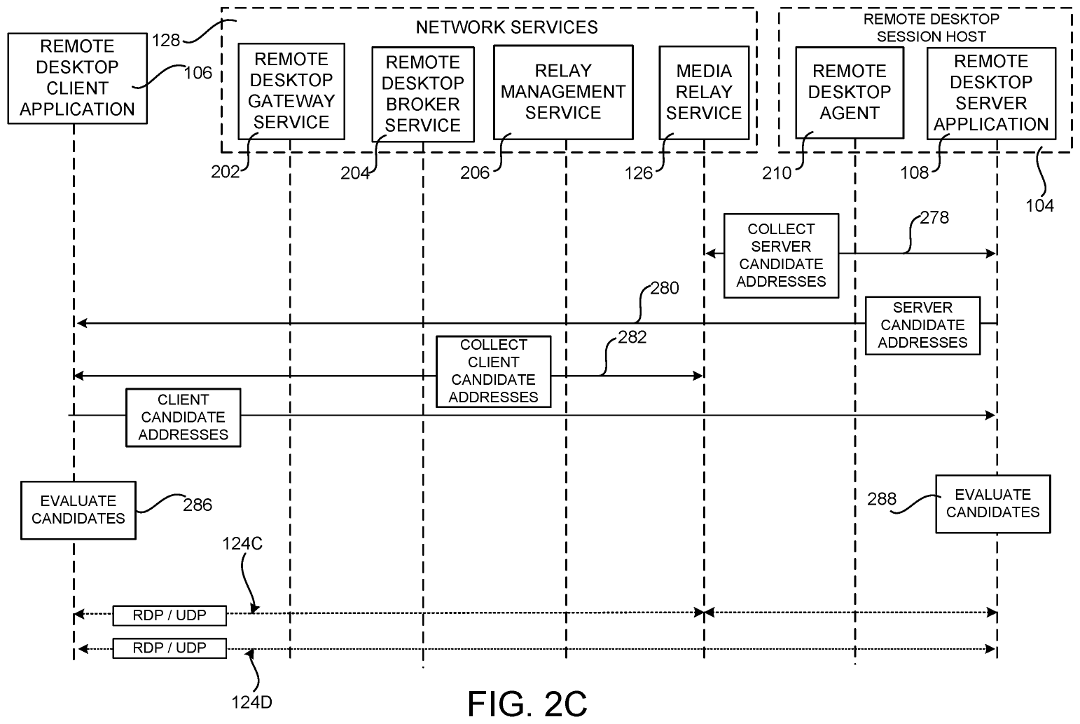

It is to be appreciated that both STUN and TURN functionality can be incorporated in the same server, or service, which is sometimes also referred simply to as a TURN/STUN server or service or simply as a TURN server or service even though it also includes STUN functionality. The media relay service 126 shown in FIGS. 1-2C is a network service that implements both TURN and STUN functionality and thus provides both address lookup and media relay functionality. Alternatively, this and/or other functionality may be split between separate servers or network services.

As will be described in greater detail below, the remote desktop client application 106 and the remote desktop server application 108 both utilize the ICE protocol 120 to identify candidate network addresses for use in establishing a networking session. Potentially, any of the candidate network addresses identified by the remote desktop client application 120 can be used to communicate with any of the candidate network addresses identified by the remote desktop server application 108. That is, the remote desktop client application 120 can potentially direct data from any of its own associated candidate network addresses to any of the candidate network addresses associated with the remote desktop server application 108 and vice versa.

In practice, however, some candidate pairs of network addresses will not be valid (i.e., will not work). For instance, if the endpoints are both behind NATs and their host candidates network addresses are private addresses in private networks, they are unlikely to be able to communicate directly using those addresses. However, if their host candidates are public addresses which, when used, do not involve routing data through any NAT devices, then the candidate pair may well be valid. Similarly, depending on the type of NAT devices (e.g., symmetric NAT devices), use of reflexive candidate network addresses may not be possible. Each candidate pair thus potentially represents a path through the network of a certain type, although such a path will only be available in practice if the candidate pair is valid.

As discussed briefly above, the ICE protocol 120 attempts to identify what it deems to be the most efficient path between endpoints based on static priorities, which are assigned to the candidate pairs described above. The order in which candidate pairs are tried is dictated by a static priority scheme defined by the ICE protocol 120, with higher priority pairs being tried ahead of lower priority pairs. The ICE protocol 120 then determines which network address is best for both endpoints to use to establish a media session.

FIG. 1 illustrates several possible outcomes following utilization of the ICE protocol 120 to obtain network addresses 122 utilized by the remote desktop client application 106 and the remote desktop server application 108 for use in establishing a network connection. In the first scenario shown in FIG. 1, implementation of the ICE protocol 120 has selected relayed network addresses 122 provided by the media relay service 126. Accordingly, a relayed network connection 124A has been established between the remote desktop client application 106 and the remote desktop server application 108 through the media relay service 126. As discussed above, the TURN functionality provided by the media relay service 126 can be utilized to relay remote desktop protocol data between the remote desktop client application 106 and the remote desktop server application 108 in this scenario.

In the second scenario illustrated in FIG. 1, implementation of the ICE protocol 120 has selected reflexive network addresses 122 that are network addresses on the public side of NAT devices. Accordingly, a non-relayed network connection 124B has been established between the remote desktop client application 106 and the remote desktop server application 108 that can be utilized to transmit remote desktop protocol data without the use of the media relay service 126.

In both scenarios shown in FIG. 1, the network connection 124 established between the remote desktop client application 106 and the remote desktop server application 108 utilizes a remote desktop protocol over UDP. The utilization of UDP rather than TCP solves many of the shortcomings of TCP described above such as, but not limited to, improved performance in noisy networking environments. The utilization of RDP over UDP can provide other technical benefits not particularly identified herein.

It is to be appreciated that the embodiments disclosed herein can be utilized with various types of remote desktop protocols. For example, and without limitation, the embodiments disclosed herein can be utilized with the Apple Remote

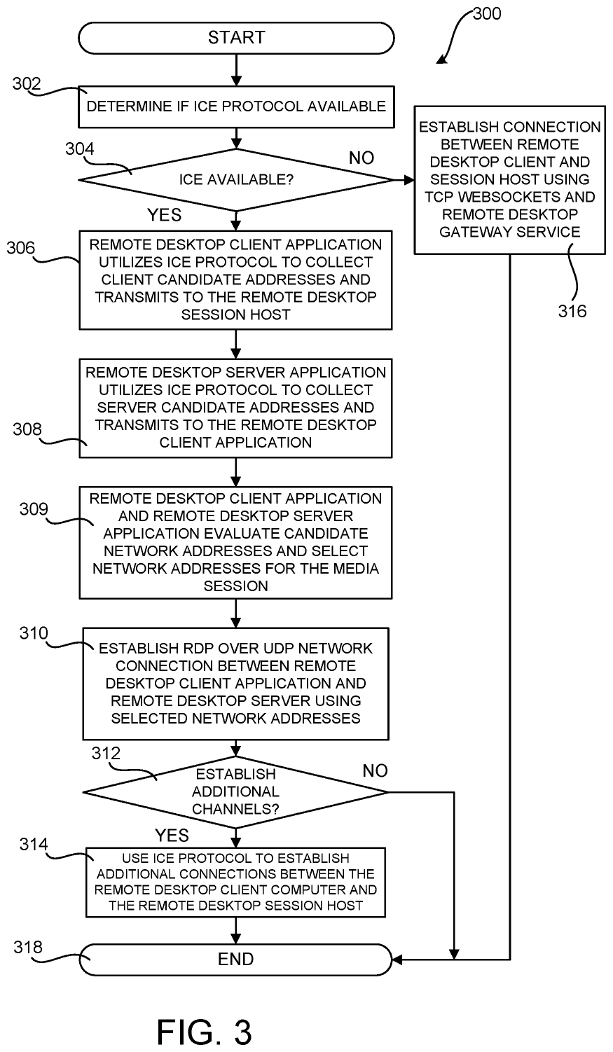

Desktop Protocol (“ARD”) from APPLE, INC., the Appliance Link Protocol (“ALP”), the HP Remote Graphics Software (“RGS”) protocol from HEWLETT PACKARD, the PC-over-IP (“PcoOP”) protocol utilized by VMWARE, the Remote Desktop Protocol (“RDP”) from MICROSOFT CORPORATION, the Remote Frame Buffer Protocol (“RFB”) utilized by VNC, the X Window System, and others. The disclosure presented herein is not limited to a particular remote desktop protocol. Additional details regarding the various embodiments disclosed herein for establishing networking sessions in remote desktop infrastructure environments will be provided below with regard to FIGS. 2A-3.

FIG. 2A is a network timing diagram that shows aspects of one mechanism disclosed herein for utilizing the ICE protocol 120 to collect candidate client and server network addresses for use in establishing a remote desktop networking session between a remote desktop client computer 102 and a remote desktop session host 104, according to one embodiment disclosed herein. As shown in FIG. 2A, in one embodiment the distributed computing network 118 provides several network services 128 that are utilized to facilitate the establishment of remote desktop connections between a remote desktop client application 106 and a remote desktop server application 108.

One of the network services 128 is the media relay service 126 described above. As mentioned above, the media relay service 126 provides STUN functionality, which allows an endpoint to determine whether it is located behind a device implementing the NAT protocol and, if so, the public address of the NAT device that is mapped to the private address of the initiating endpoint. For example, the remote desktop client application 106 might utilize the STUN protocol provided by the media relay service 126 to determine the public network address mapped to its network address by a NAT device in the private network 114. The remote desktop server application 108 can utilize the STUN functionality provided by the media relay service 126 in a similar fashion.

As also mentioned above, the media relay service 126 also provides TURN functionality. As discussed above, if both network endpoints are located behind NATs that do not permit STUN, then each will need its own respective transport address to be allocated on the media relay service 126, in which case the media session is established between those two allocated TURN server addresses and each endpoint relays/receives data in TURN messages, with data provided to the media relay service 126 being transmitted and received to/from the two TURN server addresses allocated to those endpoints in the media session. Additional details regarding this process are provided below.

As illustrated in FIG. 2A, the network services 128 provided by the distributed computing network 118 in the illustrated embodiment also include a remote desktop gateway service 202, a remote desktop broker service 204, and a media relay management service 206. Additionally, each remote desktop session host 104 executes a remote desktop agent 210 in addition to the remote desktop server application 108. As discussed above, a remote desktop session host 104 might be implemented as a physical server computer or as a virtual machine executing on a physical host. In the latter configuration, many virtual machines can execute on the same host thereby enabling the execution of many instances of the remote desktop server application 108 and many remote desktop sessions on a single physical server computer.

As will be described in greater detail below, the remote desktop gateway service 202 is a front-end service which, among other things, provides functionality to instances of the remote desktop client application 106 for determining if an instance of the media relay service 126 is available for use. Additional details regarding this process will be provided below.

The remote desktop broker service 204 provides functionality for authentication and authorization, tracking the status of remote desktop session hosts 104, tracking the applications published by remote desktop session hosts 104, selection of a particular remote desktop session host 104 for a particular user, and other types of functionality, some of which will be described in greater detail below.

The media relay management service 206 provides functionality for discovering and selecting from available instances of the media relay service 126, authentication, and other functionality described below. In this regard, it is to be appreciated that the network services 128 shown in FIGS. 2A-2C and described herein are merely illustrative and that other configurations of network services and components can be utilized in other embodiments to enable establishment of remote desktop sessions in a similar fashion. The disclosure presented herein is not limited to any particular configuration of network services 128.

As shown in FIG. 2A, each remote desktop session host 104 also includes an instance of the remote desktop server application 108 and a remote desktop agent 210. The remote desktop agent 210 is a service that communicates with the remote desktop broker service 204 to provide information regarding the health of the remote desktop session host 104 and/or the health of virtual machine instances executing thereupon, authentication of users, and other functionality, some of which will be described in detail below. The remote desktop session host 104 can also, or alternately, include other services and components not explicitly shown in FIGS. 2A-2C.

In the illustrated environment, the process of initiating a remote desktop session between an instance of the remote desktop client application 106 and an instance of the remote desktop server application 108 executing on a remote desktop session host 104 begins at operation 250, when a user selects a user interface (“UI”) element in the user interface 112 for initiating a connection. A connection can be initiated in other ways in other configurations.

In response to a user initiating a connection request, the remote desktop client application 106 transmits a request for the identity of one or more servers, or services, implementing aspects of the ICE protocol (e.g., the STUN and TURN functionality implemented by media relay service 126) to the remote desktop gateway service 202 at operation 252. In response thereto, the remote desktop gateway service 202 attempts to obtain a token for an instance of the media relay service 126 from the media relay management service 206. The token, which might also be referred to as a “TURN token” provides the network address of an instance of the media relay service 126 and a credential that can be utilized to access the instance of the media relay service 126.

If an instance of the media relay service 126 is available, the media relay management service 206 returns the TURN token to the remote desktop gateway service at operation 256. The TURN token is provided to the requesting instance of the remote desktop client application 106, in turn, at operation 258. As will be described in greater detail below, the instance of the remote desktop client application 106 can utilize the token to obtain its candidate network addresses.

It is to be appreciated that in some scenarios it might not be possible for the remote desktop gateway service 202 to obtain a token for an instance of the media relay service 126. In these instances, the remote desktop gateway service 202 can provide an instruction to the instance of the remote desktop client application 106 to establish a connection to the remote desktop server application 108 using the Web-Socket protocol over a TCP connection using the gateway. For instance, the remote desktop client application 106 might establish a Web Socket TCP connection to the remote desktop gateway service 202. The remote desktop session host 104 might also, in turn, establish a WebSocket TCP connection to the remote desktop gateway service 202 to enable communication with the remote desktop client application 106 therethrough. Other types of fallback mechanisms might be alternately utilized when a server or service supporting the ICE protocol 120 are not available for use in establishing a remote desktop session.

If the remote desktop client application 106 can obtain a TURN token, the remote desktop client application 106 can utilize the TURN token to access the media relay service 126 and obtain candidate network addresses at operation 260. As discussed above, the candidate addresses for the remote desktop client application 106 can include host candidates (i.e., addresses local to the endpoint), reflexive candidates (translated transport addresses on the public side of a NAT device obtained using the STUN protocol), and relayed candidates (network addresses allocated from a media relay service 126 implementing the TURN protocol, for instance).

Once the remote desktop client application 106 has obtained its candidate network addresses (which might be rereferred to as “client candidate addresses”), it passes the client candidate addresses 262 to the remote desktop gateway service 202 at operation 262. In turn, the remote desktop gateway service 202 obtains a TURN token from the media relay management service 206 for use by the remote desktop server application 108 at operations 264 and 266. The remote desktop gateway service 202 then passes the TURN token to the remote desktop agent 210 and, in turn, to the appropriate instance of the remote desktop server application 108 at operation 268. The remote desktop gateway service 202 also provides the client candidate addresses obtained in the manner described above to the remote desktop server application 108 at operation 268.

At operation 270, the remote desktop server application 108 utilizes the TURN token to obtain its candidate network addresses (which might be referred to herein as “server candidate addresses”). As in the case of the remote desktop client application 106, the candidate addresses for the remote desktop server application 108 can include host candidates (i.e., addresses local to the endpoint), reflexive candidates (translated transport addresses on the public side of a NAT device obtained using the STUN protocol), and relayed candidates (network addresses allocated from a media relay service 126 implementing the TURN protocol, for instance).

The illustrated process for establishing a remote desktop session between a remote desktop client computer 102 and a remote desktop session host 104 continues in FIG. 2B. In particular, at operation 272, the remote desktop server application 108 transmits the identified server candidate addresses back through the service chain and, ultimately, to the remote desktop client application 106. At this point, the remote desktop client application 106 and the remote desktop server application 108 each have the client candidate addresses and the server candidate addresses.

At operations 274 and 276, the remote desktop client application 106 and the remote desktop server application 108, respectively, evaluate the client candidate addresses and the server candidate addresses according to the ICE protocol. In particular, candidate addresses are evaluated by performing connectivity checks on candidate pairs of client and server network addresses.

Following the connectivity checks, the remote desktop client application 106 can nominate a pair of network addresses 122 and provide the nominated network addresses 122 to the remote desktop server application 108 for use in connection establishment. In this regard, it is to be appreciated that that the process for obtaining client and server candidates and for evaluating candidates has been simplified herein for ease of discussion. As discussed above, additional details regarding these processes can be found in the publicly available RFC 5245, Interactive Connectivity Establishment (ICE): A Protocol for Network Address Translator (NAT) Traversal for Offer/Answer Protocols, J. Rosenberg (Apr. 2010).

After a pair of network addresses 122 have been selected for the remote desktop session between the remote desktop client application 106 and the remote desktop server application 108, a connection between the two applications can be established. In this regard, FIG. 2B illustrates several possible outcomes following utilization of the ICE protocol 120 in the manner described above to obtain network addresses 122 utilized by the remote desktop client application 106 and the remote desktop server application 108 for use in establishing a network connection.

In the first scenario shown in FIG. 2B, implementation of the ICE protocol 120 has selected relayed network addresses 122 provided by the media relay service 126. Accordingly, a relayed network connection 124A has been established between the remote desktop client application 106 and the remote desktop server application 108 through the media relay service 126. As discussed above, the TURN functionality provided by the media relay service 126 can be utilized to relay remote desktop protocol data between the remote desktop client application 106 and the remote desktop server application 108 in this scenario.

In the second scenario illustrated in FIG. 2B, implementation of the ICE protocol 120 has selected reflexive network addresses 122 that are network addresses on the public side of NAT devices. Accordingly, a non-relayed network connection 124B has been established between the remote desktop client application 106 and the remote desktop server application 108 that can be utilized to transmit remote desktop protocol data without the use of the media relay service 126.

In both scenarios shown in FIG. 2B, the network connection 124A or 124B established between the remote desktop client application 106 and the remote desktop server application 108 utilizes the remote desktop protocol over UDP. The utilization of UDP rather than TCP as a transport protocol for remote desktop protocol data solves many of the shortcomings of TCP described above such as, but not limited to, improved performance in noisy networking environments. The utilization of RDP over UDP can provide other technical benefits not particularly identified herein.

FIG. 2C is a network timing diagram that shows aspects of one mechanism disclosed herein for establishing additional remote desktop protocol communication channels (which might be referred to herein as “remote desktop protocol transport channels”) between a remote desktop client computer 102 and a remote desktop session host 104, according to one embodiment disclosed herein. In the examples shown in FIGS. 2A and 2B, described above, a main remote desktop protocol transport channel has been established (i.e., the network connection 124A or 124B). However, it might be desirable in certain situations to establish additional remote desktop protocol transport channels between the remote desktop client computer 102 and the remote desktop session host 104 for use in transmitting other types of remote desktop protocol data. Each channel can be utilized to transmit different types of data per the applicable remote desktop protocol standard. FIG. 2C illustrates this process in detail.

The process for establishing a second or subsequent remote desktop protocol transport channel between the remote desktop client computer 102 and the remote desktop session host 104 begins at operation 278, where the remote desktop server application 108 collects its server candidate addresses using the ICE protocol in the same way as described above with regard to FIGS. 2A and 2B (i.e., using the media relay service 126).

Once the remote desktop server application 108 has collected it server candidate addresses, it transmits the server candidate addresses to the remote desktop client application 106 at operation 280. Since a network connection 124A or 124B has been previously established, this network connection can be utilized to transmit the server candidate addresses to the remote desktop client application 106. This avoids the service setup process described above with regard to FIG. 2A and streamlines the process of setting up a second or subsequent communications channel.

At operation 282, the remote desktop client application 106 collects the client candidate addresses using the ICE protocol in the manner described above with regard to FIG. 2A. The remote desktop client application 106 then transmits the client candidate addresses to the remote desktop server application 108 using the existing network connection 124A or 124B. The remote desktop client application 106 and the remote desktop server application 108 then evaluate the candidates and select network addresses 122 for use in establishing a network connection at operations 286 and 288 in the manner described above.

After a pair of network addresses 122 have been selected for the second or subsequent transport channel between the remote desktop client application 106 and the remote desktop server application 108, the second or subsequent remote desktop protocol transport channel between the two applications can be established. In this regard, FIG. 2C illustrates several possible outcomes following utilization of the ICE protocol 120 in the manner described above to obtain network addresses 122 utilized by the remote desktop client application 106 and the remote desktop server application 108 for use in establishing a second or subsequent communication channel.

In the first scenario shown in FIG. 2C, implementation of the ICE protocol 120 has selected relayed network addresses 122 provided by the media relay service 126. Accordingly, a relayed network connection 124C has been established between the remote desktop client application 106 and the remote desktop server application 108 through the media relay service 126. In the second scenario illustrated in FIG. 2C, implementation of the ICE protocol 120 has selected reflexive network addresses 122 that are network addresses on the public side of NAT devices. Accordingly, a non-relayed network connection 124D has been established for the second or subsequent communication channel between the remote desktop client application 106 and the remote desktop server application 108. This process can be repeated in order to create additional transport channels between the remote desktop client application 106 and the remote desktop server application 108.

FIG. 3 is a flow diagram showing a routine 300 that illustrates aspects of the operation of the remote desktop client computer 102 and the remote desktop session host 104 for performing session establishment in a remote desktop infrastructure environment 100 such as that illustrated in FIGS. 1-2C and described above, according to one embodiment disclosed herein. It should be appreciated that the logical operations described herein with regard to FIG. 3, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 300 begins at operation 302, where the remote desktop client application 106 determines whether the ICE protocol 120 is available and should be utilized. As discussed above with regard to FIG. 2A, this might be accomplished by transmitting a request to the remote desktop gateway service 202 which, in turn, attempts to obtain a TURN token from an instance of the media relay service 126. If a TURN token can be obtained, this indicates that the ICE protocol 120 can be utilized and the routine 300 proceeds from operation 304 to operation 306.

If, at operation 304, it is determined that a TURN token cannot be obtained, the routine 300 proceeds from operation 304 to operation 316, where a fallback procedure might be utilized in order to establish a connection between the remote desktop client application 106 and the remote desktop server application 108. In particular, and as discussed briefly above, the remote desktop gateway service 202 might provide an instruction to the instance of the remote desktop client application 106 to establish a connection to the remote desktop server application 108 using the Web Socket protocol over a TCP connection using a gateway.

For instance, the remote desktop client application 106 might establish a WebSocket TCP connection to the remote desktop gateway service 202. The remote desktop session host 104 might also, in turn, establish a Web Socket TCP connection to the remote desktop gateway service 202 to enable communication with the remote desktop client application 106 therethrough. Other types of fallback mechanisms might be alternately be utilized when a server or service supporting aspects of the ICE protocol 120 are not available for use in establishing a remote desktop session. The routine 300 proceeds from operation 316, to operation 318, where it ends.

If the ICE protocol 120 is to be utilized, the routine 300 proceeds from operation 304 to operation 306. At operation 306, the remote desktop client application 106 utilizes an implementation of the ICE protocol 120 to obtain the client candidate network addresses in the manner described above with regard to FIGS. 2A and 2B. Once the remote desktop client application 106 has obtained the client candidate network addresses, it transmits the client candidate network addresses to the identified instance of the remote desktop server application 108, also in the manner described above with regard to FIGS. 2A and 2B.

From operation 306, the routine 300 proceeds to operation 308, where the remote desktop server application 108 utilizes an implementation of the ICE protocol 120 to obtain the server candidate addresses in the manner described above with regard to FIGS. 2A and 2B. Once the remote desktop server application 108 has obtained the server candidate addresses, it transmits the server candidate addresses to the remote desktop client application 106, also in the manner described above with regard to FIGS. 2A and 2B. The routine 300 then proceeds from operation 308 to operation 309.

At operation 309, the remote desktop server application 108 and the remote desktop client application 106 evaluate the client and server candidate addresses using the ICE protocol and select network addresses 122 for the remote desktop session in the manner described above with regard to FIG. 2C. The routine 300 then proceeds from operation 309 to operation 310, where an RDP over UDP network connection is established between the remote desktop server application 108 and the remote desktop client application 106 using the network addresses selected at operation 309. As discussed above, the network connection 124A or 124B might be established using local network addresses, relayed network addresses, such as through a media relay service 216 implementing the TURN protocol or using translated transport addresses on the public side of a NAT device.

From operation 310, the routine 300 proceeds to operation 312, where a determination is made as to whether additional remote desktop protocol transport channels are to be established between the remote desktop server application 108 and the remote desktop client application 106. If so, the routine 300 proceeds from operation 312 to operation 314, where the ICE protocol 120 can be utilized to establish additional communication channels between the remote desktop server application 108 and the remote desktop client application 106 in the manner disclosed above with regard to FIG. 3C. Once the communication channels have been established, or if no additional communication channels are to be established, the routine 300 proceeds to operation 318, where it ends.

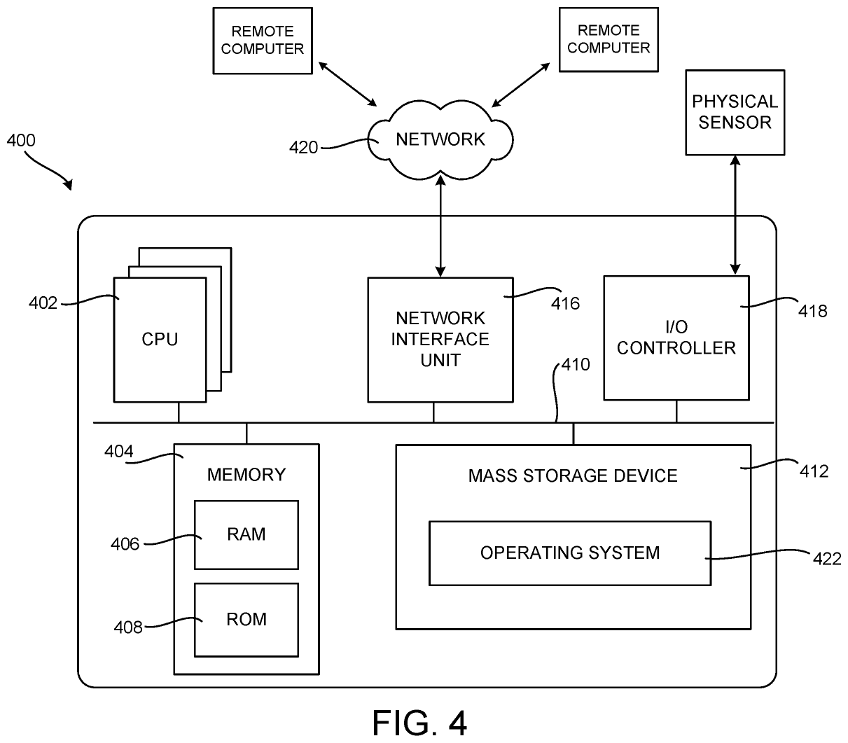

FIG. 4 is a computer architecture diagram showing an illustrative computer hardware and software architecture for a computing device that can implement the various technologies presented herein. In particular, the architecture illustrated in FIG. 4 can be utilized to implement a server computer, mobile phone, an e-reader, a smartphone, a desktop computer, an AR/VR device, a tablet computer, a laptop computer, or another type of computing device. For example, and without limitation, the compute architecture shown in FIG. 4 might be utilized to implement the remote desktop client computer 102 or the remote desktop session host 104.

The computer 400 illustrated in FIG. 4 includes a central processing unit 402 (“CPU”), a system memory 404, including a random-access memory 406 (“RAM”) and a read-only memory (“ROM”) 408, and a system bus 410 that couples the memory 404 to the CPU 402. A basic input/output system (“BIOS” or “firmware”) containing the basic routines that help to transfer information between elements within the computer 400, such as during startup, can be stored in the ROM 408. The computer 400 further includes a mass storage device 412 for storing an operating system 422, application programs like the remote desktop client application 106 and the remote desktop server application 108, and other types of programs. The mass storage device 412 can also be configured to store other types of programs and data.

The mass storage device 412 is connected to the CPU 402 through a mass storage controller (not shown) connected to the bus 410. The mass storage device 412 and its associated computer readable media provide non-volatile storage for the computer 400. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 400. For purposes of the claims, the phrase “computer storage medium,” and variations thereof, does not include waves or signals per se or communication media.

According to various configurations, the computer 400 can operate in a networked environment using logical connections to remote computers through a network such as the network 420. The computer 400 can connect to the network 420 through a network interface unit 416 connected to the bus 410. It should be appreciated that the network interface unit 416 can also be utilized to connect to other types of networks and remote computer systems such as those shown in FIG. 1 and described above. The computer 400 can also include an input/output controller 418 for receiving and processing input from a number of other devices, including a keyboard, mouse, touch input, an electronic stylus (not shown in FIG. 4), or a physical sensor such as a video camera. Similarly, the input/output controller 418 can provide output to a display screen or other type of output device (also not shown in FIG. 4).

It should be appreciated that the software components described herein, when loaded into the CPU 402 and executed, can transform the CPU 402 and the overall computer 400 from a general-purpose computing device into a special-purpose computing device customized to facilitate the functionality presented herein. The CPU 402 can be constructed from any number of transistors or other discrete circuit elements, which can individually or collectively assume any number of states. More specifically, the CPU 402 can operate as a finite-state machine, in response to executable instructions contained within the software modules disclosed herein. These computer-executable instructions can transform the CPU 402 by specifying how the CPU 402 transitions between states, thereby transforming the transistors or other discrete hardware elements constituting the CPU 402.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 400 in order to store and execute the software components presented herein. It also should be appreciated that the architecture shown in FIG. 4 for the computer 400, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 400 might not include all of the components shown in FIG. 4, can include other components that are not explicitly shown in FIG. 4, or can utilize an architecture completely different than that shown in FIG. 4.

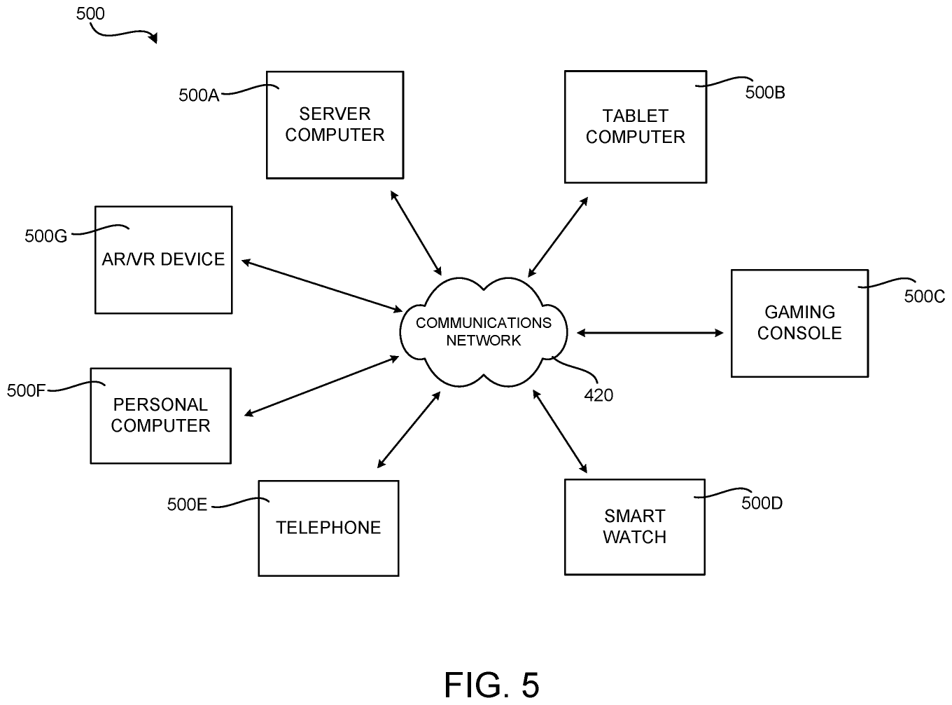

FIG. 5 is a network diagram illustrating a distributed network computing environment 500 in which aspects of the disclosed technologies can be implemented, according to various embodiments presented herein. As shown in FIG. 5, one or more server computers 500A can be interconnected via a communications network 420 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 500B, a gaming console 500C, a smart watch 500D, a telephone 500E, such as a smartphone, a personal computer 500F, and an AR/VR device 500G.

In a network environment in which the communications network 420 is the Internet, for example, the server computer 500A can be a dedicated server computer operable to process and communicate data to and from the client computing devices 500B-500G via any of a number of known protocols, such as, hypertext transfer protocol (“HTTP”), file transfer protocol (“FTP”), a remote desktop protocol, TCP, UDP, or simple object access protocol (“SOAP”). Additionally, the networked computing environment 500 can utilize various data security protocols such as secured socket layer (“SSL”) or pretty good privacy (“PGP”). Each of the client computing devices 500B-500G can be equipped with an operating system operable to support one or more computing applications or terminal sessions such as a web browser (not shown in FIG. 5), or other graphical user interface (not shown in FIG. 5), or a mobile desktop environment (not shown in FIG. 5) to gain access to the server computer 500A.

The server computer 500A can be communicatively coupled to other computing environments (not shown in FIG. 5) and receive data regarding a participating user's interactions/resource network. In an illustrative operation, a user (not shown in FIG. 5) may interact with a computing application running on a client computing device 500B-500G to obtain desired data and/or perform other computing applications.

The data and/or computing applications may be stored on the server 500A, or servers 500A, and communicated to cooperating users through the client computing devices 500B-500G over an exemplary communications network 420. A participating user (not shown in FIG. 5) may request access to specific data and applications housed in whole or in part on the server computer 500A. These data may be communicated between the client computing devices 500B-500G and the server computer 500A for processing and storage.

The server computer 500A can host computing applications, processes and applets for the generation, authentication, encryption, and communication of data and applications, and may cooperate with other server computing environments (not shown in FIG. 5), third party service providers (not shown in FIG. 5), network attached storage (“NAS”) and storage area networks (“SAN”) to realize application/data transactions. Moreover, it is to be appreciate that the various mechanisms described with regard to FIGS. 1-3 can be implemented within the distributed network computing environment shown in FIG. 5. For example, and without limitation, the tablet computer 500B or the personal computer 500F might utilize the mechanism described above to establish a remote desktop session with the server computer 500A.

It should also be appreciated that the computing architecture shown in FIG. 4 and the distributed network computing environment shown in FIG. 5 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method for establishing a network session in a remote desktop infrastructure environment, the method comprising: utilizing an Interactive Connectivity Establishment (ICE) protocol to identify a first network address for use by a remote desktop client computer to communicate with a remote desktop session host; utilizing the ICE protocol to identify a second network address for use by the remote desktop session host to communicate with the remote desktop client computer; and establishing a first network connection between the remote desktop client computer and the remote desktop session host using the first network address and the second network address, the network connection comprising a remote desktop protocol over user datagram protocol (UDP) connection.

Clause 2. The computer-implemented method of clause 1, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

Clause 3. The computer-implemented method of clauses 1 or 2, wherein the first network connection between the remote desktop client and the remote desktop session host does not utilize a media relay service.

Clause 4. The computer-implemented method of any of clauses 1-3, wherein first network connection comprises a first remote desktop protocol transport channel

Clause 5. The computer-implemented method of any of clauses 1-4, further comprising: utilizing the ICE protocol to identify a third network address for use by the remote desktop client computer to communicate with the remote desktop session host; utilizing the ICE protocol to identify a fourth network address for use by the remote desktop session host to communicate with the remote desktop client computer; and establishing a second network connection between the remote desktop client computer and the remote desktop session host using the third network address and the fourth network address, the network connection comprising a remote desktop protocol over UDP connection.

Clause 6. The computer-implemented method of any of clauses 1-5, wherein second network connection comprises a second remote desktop protocol transport channel.

Clause 7. The computer-implemented method of any of clauses 1-6, further comprising: determining that the ICE protocol cannot be utilized to establish the first network connection between the remote desktop client computer and the remote desktop session host; and responsive to determining that the ICE protocol cannot be utilized, establish a first Transmission Control Protocol (TCP) WebSocket connection between the remote desktop client application and a gateway and establish a second TCP Web Socket connection between the remote desktop session host and the gateway for enabling communication between the remote desktop client computer and the remote desktop session host.

Clause 8. A computer-readable storage medium having computer executable instructions stored thereupon which, when executed by a computer, cause the computer to: utilize an Interactive Connectivity Establishment (ICE) protocol to identify a plurality of client candidate network addresses for use by a remote desktop client computer to communicate with a remote desktop session host; receive a plurality of server candidate network addresses for use by the remote desktop session host to communicate with the remote desktop client computer; select a pair of network addresses from the plurality of client candidate network addresses and the plurality of server candidate network addresses using the ICE protocol; and establish a first network connection between the remote desktop client computer and the remote desktop session host using the selected pair of network addresses, the network connection comprising a remote desktop protocol over user datagram protocol (UDP) connection.

Clause 9. The computer-readable storage medium of clause 8, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

Clause 10. The computer-readable storage medium of clauses 8 or 9, wherein the first network connection between the remote desktop client and the remote desktop session host does not utilize a media relay service.

Clause 11. The computer-readable storage medium of any of clauses 8-10, wherein first network connection comprises a first remote desktop protocol transport channel.

Clause 12. The computer-readable storage medium of any of clauses 8-11, having further computer-executable instructions stored thereupon which, when executed by the computer, cause the computer to: receive a second plurality of server candidate network addresses for use by the remote desktop session host to communicate with the remote desktop client computer; utilize the ICE protocol to identify a second plurality of client candidate network addresses for use by the remote desktop client computer to communicate with the remote desktop session host; select a second pair of network addresses from the second plurality of client candidate network addresses and the second plurality of server candidate network addresses using the ICE protocol; and establish a second network connection between the remote desktop client computer and the remote desktop session host using the selected second pair of network addresses, the network connection comprising a remote desktop protocol over UDP connection.

Clause 13. The computer-readable storage medium of any of clauses 8-12, wherein the second network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

Clause 14. The computer-readable storage medium of any of clauses 8-13, wherein second network connection comprises a second remote desktop protocol transport channel.

Clause 15. A computing device, comprising: at least one processor; and a computer-readable storage medium having computer-executable instructions stored thereupon which, when executed by the at least one processor, cause the computing device to: receive a plurality of client candidate network addresses at a remote desktop server application; utilize an Interactive Connectivity Establishment (ICE) protocol to identify a plurality of server candidate network addresses for use by the remote desktop server application to communicate with a remote desktop client application; transmit the plurality of server candidate network addresses from the remote desktop server application to the remote desktop client application; select a pair of network addresses from the plurality of client candidate network addresses and the plurality of server candidate network addresses using the ICE protocol; and establish a first network connection between the remote desktop client application and the remote desktop server application using the selected pair of network addresses, the network connection comprising a remote desktop protocol over user datagram protocol (UDP) connection.

Clause 16. The computing device of clause 15, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

Clause 17. The computing device of clauses 15 or 16, wherein the first network connection between the remote desktop client and the remote desktop session host does not utilize a media relay service.

Clause 18. The computing device of any of clauses 15-17, wherein the computer-readable storage medium has further computer-executable instructions stored thereupon which, when executed by the at least one processor, cause the computing device to: utilize the ICE protocol to identify a second plurality of server candidate network addresses for use by the remote desktop server application to communicate with the remote desktop client application; transmit the second plurality of server candidate network addresses to the remote desktop client application over the first network connection; receive a second plurality of client candidate network addresses from the remote desktop client application over the first network connection; select a second pair of network addresses from the second plurality of client candidate network addresses and the second plurality of server candidate network addresses using the ICE protocol; and establish a second network connection between the remote desktop client application and the remote desktop server application using the selected second pair of network addresses, the network connection comprising a remote desktop protocol over UDP connection.

Clause 19. The computing device of any of clauses 15-18, wherein the second network connection between the remote desktop client application and the remote desktop server application comprises a network connection between the remote desktop client application and a media relay service implementing a Traversal Using Relays around NAT (TURN) protocol and a network connection between the remote desktop server application and the media relay service.

Clause 20. The computing device of any of clauses 15-19, wherein second network connection comprises a second remote desktop protocol transport channel.

Based on the foregoing, it should be appreciated that technologies for performing session establishment in remote desktop infrastructure environments have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

1. A computer-implemented method for establishing a network session in a remote desktop infrastructure environment, the method comprising:
utilizing an Interactive Connectivity Establishment (ICE) protocol to identify a first network address for use by a remote desktop client computer to communicate with a remote desktop session host;
utilizing the ICE protocol to identify a second network address for use by the remote desktop session host to communicate with the remote desktop client computer; and
establishing a first network connection between the remote desktop client computer and the remote desktop session host using the first network address and the second network address, the network connection comprising a remote desktop protocol over user datagram protocol (UDP) connection.

2. The computer-implemented method of claim 1, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

3. The computer-implemented method of claim 1, wherein the first network connection between the remote desktop client and the remote desktop session host does not utilize a media relay service.

4. The computer-implemented method of claim 1, wherein the first network connection comprises a first remote desktop protocol transport channel.

5. The computer-implemented method of claim 1, further comprising:
utilizing the ICE protocol to identify a third network address for use by the remote desktop client computer to communicate with the remote desktop session host;
utilizing the ICE protocol to identify a fourth network address for use by the remote desktop session host to communicate with the remote desktop client computer; and
establishing a second network connection between the remote desktop client computer and the remote desktop session host using the third network address and the fourth network address, the network connection comprising a remote desktop protocol over UDP connection.

6. The computer-implemented method of claim 5, wherein the second network connection comprises a second remote desktop protocol transport channel.

7. (canceled)

8. A computer-readable storage medium having computer-executable instructions stored thereupon which, when executed by a computer, cause the computer to:
utilize an Interactive Connectivity Establishment (ICE) protocol to identify a plurality of client candidate network addresses for use by a remote desktop client computer to communicate with a remote desktop session host;
receive a plurality of server candidate network addresses for use by the remote desktop session host to communicate with the remote desktop client computer;
select a pair of network addresses from the plurality of client candidate network addresses and the plurality of server candidate network addresses using the ICE protocol; and
establish a first network connection between the remote desktop client computer and the remote desktop session host using the selected pair of network addresses, the network connection comprising a remote desktop protocol over user datagram protocol (UDP) connection.

9. The computer-readable storage medium of claim 8, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

10. The computer-readable storage medium of claim 8, wherein the first network connection between the remote desktop client and the remote desktop session host does not utilize a media relay service.

11. The computer-readable storage medium of claim 8, wherein first network connection comprises a first remote desktop protocol transport channel.

12. The computer-readable storage medium of claim 8, having further computer-executable instructions stored thereupon which, when executed by the computer, cause the computer to:
receive a second plurality of server candidate network addresses for use by the remote desktop session host to communicate with the remote desktop client computer;
utilize the ICE protocol to identify a second plurality of client candidate network addresses for use by the remote desktop client computer to communicate with the remote desktop session host;
select a second pair of network addresses from the second plurality of client candidate network addresses and the second plurality of server candidate network addresses using the ICE protocol; and
establish a second network connection between the remote desktop client computer and the remote desktop session host using the selected second pair of network addresses, the network connection comprising a remote desktop protocol over UDP connection.

13. The computer-readable storage medium of claim 12, wherein the second network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

14. The computer-readable storage medium of claim 13, wherein second network connection comprises a second remote desktop protocol transport channel.

15-20. (Canceled)

21. A computing device, comprising:
at least one processor; and
a computer-readable storage medium having computer-executable instructions stored thereupon which, when executed by the at least one processor, cause the computing device to:
utilize an Interactive Connectivity Establishment (ICE) protocol to identify a first network address for use by a remote desktop client computer to communicate with a remote desktop session host;
utilize the ICE protocol to identify a second network address for use by the remote desktop session host to communicate with the remote desktop client computer; and
establish a first network connection between the remote desktop client computer and the remote desktop session host using the first network address and the second network address, the network connection comprising a remote desktop protocol over user datagram protocol (UDP) connection.

22. The computing device of claim 21, wherein the first network connection between the remote desktop client computer and the remote desktop session host comprises a network connection between the remote desktop client computer and a media relay service implementing a Traversal Using Relays around NAT (TURN) protocol and a network connection between the remote desktop session host and the media relay service.

23. The computing device of claim 21, wherein the first network connection between the remote desktop client and the remote desktop session host does not utilize a media relay service.

24. The computing device of claim 21, wherein the first network connection comprises a first remote desktop protocol transport channel.

25. The computing device of claim 21, wherein the computer-readable storage medium has further computer-executable instructions stored thereupon to:
utilize the ICE protocol to identify a third network address for use by the remote desktop client computer to communicate with the remote desktop session host;
utilize the ICE protocol to identify a fourth network address for use by the remote desktop session host to communicate with the remote desktop client computer; and
establish a second network connection between the remote desktop client computer and the remote desktop session host using the third network address and the fourth network address, the network connection comprising a remote desktop protocol over UDP connection.

26. The computing device of claim 25, wherein the second network connection comprises a second remote desktop protocol transport channel.
